(19) United States
(12) Patent Application Publication
(10) Pub. No.: US 2011/0135359 A1
(43) Pub. Date: Jun. 9, 2011

(54) FIXING DEVICE INCLUDING AUXILIARY HEAT GENERATING MEMBER COMPRISING REGION WIDER THAN HEAT GENERATION REGION

(75) Inventors: Kazuhiko KIKUCHI, Kanagawa (JP); Satoshi KINOUCHI, Tokyo (JP); Shuji YOKOYAMA, Shizuoka (JP); Hiroyuki KUNUGI, Shizuoka (JP); Hiroshi NAKAYAMA, Shizuoka (JP); Yoshiaki OKANO, Shizuoka (JP); Setsuo TAKADA, Shizuoka (JP); Toshihiro SONE, Kanagawa (JP)

(73) Assignees: Kabushiki Kaisha Toshiba, Tokyo (JP); Toshiba TEC Kabushiki Kaisha, Tokyo (JP)

(21) Appl. No.: 12/951,791

(22) Filed: Nov. 22, 2010

Related U.S. Application Data
(60) Provisional application No. 61/266,600, filed on Dec. 4, 2009.
(60) Provisional application No. 61/266,613, filed on Dec. 4, 2009.

(51) Int. Cl. G03G 15/20

(52) U.S. Cl. 399/333

(57) ABSTRACT

According to one embodiment, a fixing device includes: a fixing belt comprising a first metal heat generating layer; a pressing unit opposing to the outer circumference of the fixing belt; an induction-current generating coil presented near the circumferential surface of the fixing belt; a nip forming member present on the inner side of the fixing belt and configured to press the fixing belt against the pressing unit; and an auxiliary heat generating member present in a heating region by the induction-current generating coil on the inner side of the fixing belt, having a second metal heat generating layer, and extending to the outer side of the heating region by the induction-current generating coil.

### CROSS-REFERENCE TO RELATED APPLICATION

This application is based upon and claims the benefit of priority from Provisional U.S. Applications 61/266,600 filed on Dec. 4, 2009 and 61/266,613 filed on Dec. 4, 2009 the entire contents of which are incorporated herein by reference.

### FIELD

Embodiments described herein relate to a fixing device used in an image forming apparatus, the fixing device realizing an increase in speed of startup and improving safety during abnormal heat generation.

### BACKGROUND

As a fixing device used in an image forming apparatus such as a copying machine or a printer, there is a fixing device in which a fixing belt having a heat generating layer reduced in thickness and a reduced heat capacity is used in order to save energy and obtain an increase in speed of startup, and a pressing pad is used as nip forming means.

Since the fixing belt has a small heat capacity, it is likely that the temperature of the fixing belt rapidly drops because of heat transfer to a sheet during fixing. When the temperature of the fixing belt rapidly drops, the fixing belt tends to cause temperature unevenness at a belt cycle. There is a risk that the temperature unevenness of the fixing belt causes deterioration in image quality such as gloss unevenness on the sheet after the fixing.

### BRIEF DESCRIPTION OF THE DRAWINGS

FIG. 1 is a schematic diagram of an MFP mounted with a fixing unit according to an embodiment;

FIG. 2 is a schematic diagram of the fixing unit viewed from a side and a schematic diagram of a control block focusing on the fixing unit according to the embodiment;

FIG. 3 is a schematic explanatory diagram of a temperature detecting section of the fixing belt according to the embodiment;

FIG. 4 is a schematic explanatory diagram of layer structures of the fixing belt and an auxiliary heat generating member according to the embodiment;

FIG. 5 is a schematic explanatory diagram of the structure of a pressing pad according to the embodiment; and

FIG. 6 is a schematic explanatory diagram of an example of another layer structure of the auxiliary heat generating member.

### DETAILED DESCRIPTION

In general, according to one embodiment, a fixing device includes: a fixing belt comprising a first metal heat generating layer; a pressing unit opposing to the outer circumference of the fixing belt; an induction-current generating coil present near the circumferential surface of the fixing belt; a nip forming member presented on the inner side of the fixing belt and configured to press the fixing belt against the pressing unit; and an auxiliary heat generating member present in a heating region by the induction-current generating coil on the inner side of the fixing belt, having a second metal heat generating layer, and extending to the outer side of the heating region by the induction-current generating coil.

An embodiment is explained below.

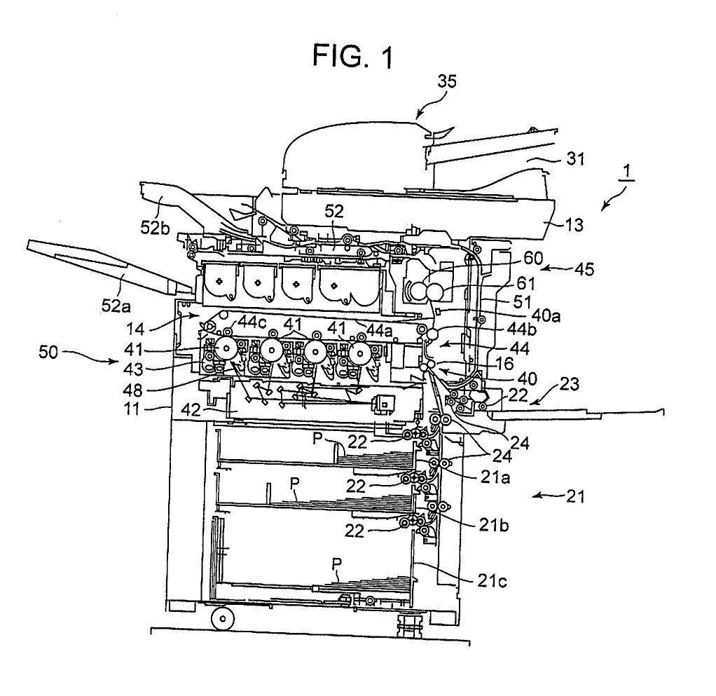

FIG. 1 is a schematic diagram of a multi functional peripheral (hereinafter abbreviated as MFP) 1 as an image forming apparatus, mounted with a fixing device according to the embodiment. The MFP 1 includes a scanner unit 13 configured to read an image, a printer unit 14 as an image forming unit, a paper feeding unit 21 configured to feed a sheet P as a recording medium, and a paper discharge unit 52 including a first tray 52a and a second tray 52b on which the sheet P discharged by the printer unit 14 are accumulated. The MFP 1 has a manual paper feeding unit 23 on a side of a housing 11. The MFP 1 includes a conveying mechanism 40 for the sheet P in a section extending from the paper feeding unit 21 or the manual paper feeding unit 23 to the paper discharge unit 52 through the printer unit 14.

The scanner unit 13 scans an original document supplied by an auto document feeder (ADF) 35 and captures image information. After the scanner unit 13 ends the reading of the image information, the ADF 35 discharges the original document to a document discharge unit 31.

The printer unit 14 forms, on the sheet P, an image corresponding to input image information or the read image information from the scanner unit 13. The printer unit 14 includes four sets of image forming stations 50 for yellow (Y), magenta (M), cyan (C), and black (K), an exposing device 42, and a transfer unit 44 configured to transfer toner images formed by the image forming stations 50 onto the sheet P of an arbitrary size. The printer unit 14 includes a fixing unit 45 as a fixing device, configured to fix the toner images on the sheet P.

The four sets of image forming stations 50 have the same structure. Each of the image forming stations 50 includes a photoconductive drum 41, a charging device 48 configured to uniformly charge the photoconductive drum 41, and a developing device 43 configured to develop an electrostatic latent image formed on the photoconductive drum 41 by irradiation of exposure light of the exposing device 42 after the charging and form a toner image. The transfer unit 44 includes an intermediate transfer belt 44a, a primary transfer roller 44c, and a secondary transfer roller 44b.

The paper feeding unit 21 includes an upper-stage paper feeding cassette 21a, a lower-stage paper feeding cassette 21b, and a large capacity cassette 21c. The conveying mechanism 40 includes conveying rollers 24 and a registration roller 16 configured to supply the sheet P, which is extracted from the paper feeding unit 21 or the manual paper feeding unit 23 by a pickup roller 22, to the transfer unit 44. The conveying mechanism 40 conveys the sheet P having the fixed toner image to the paper discharge unit 52 or a circulation path 51 through the transfer unit 44 and the fixing unit 45. The paper discharge unit 52 discharges the sheet P to the first tray 52a or the second tray 52b or reverses the sheet P in the direction of the circulation path 51. The circulation path 51 leads the sheet P to the transfer unit 44 again. The conveying mechanism 40 includes a sheet sensor 40a configured to detect the sheet P, in a section extending from the transfer unit 44 to the fixing unit 45.

Upon starting image formation, the MFP 1 charges the photoconductive drum 41 with the charger 48, and thereafter irradiates the photoconductive drum 41 with exposure light with the exposure device 42 to thereby form an electrostatic latent image corresponding to the exposure light on the photoconductive drum 41. The developing device 43 provides toner for the electrostatic latent image on the photoconductive drum 41 to visualize the electrostatic latent image. The transfer unit 44 transfers via the intermediate transfer belt 44a the toner image obtained by visualizing the electrostatic latent image on the photoconductive drum 41 onto the sheet P.

The sheet P supplied from the paper feeding unit 21 or the manual paper feeding unit 23 goes through the conveying mechanism 40 to reach a nip of the intermediate transfer belt 44a and the secondary transfer roller 44b in synchronization with the toner image primarily transferred onto the intermediate transfer belt 44a. The secondary transfer roller 44b secondarily transfers the toner image on the intermediate transfer belt 44a onto the sheet P passing through the nip of the intermediate transfer belt 44a and the secondary transfer roller 44b. The fixing unit 45 fixes the toner image on the sheet P. The paper discharge unit 52 discharges the sheet P having the toner image fixed thereon onto the first tray 52a or the second tray 52b. The circulation path 51 leads the sheet P having the toner image fixed thereon in the direction of the secondary transfer roller 44b of the transfer unit 44 again.

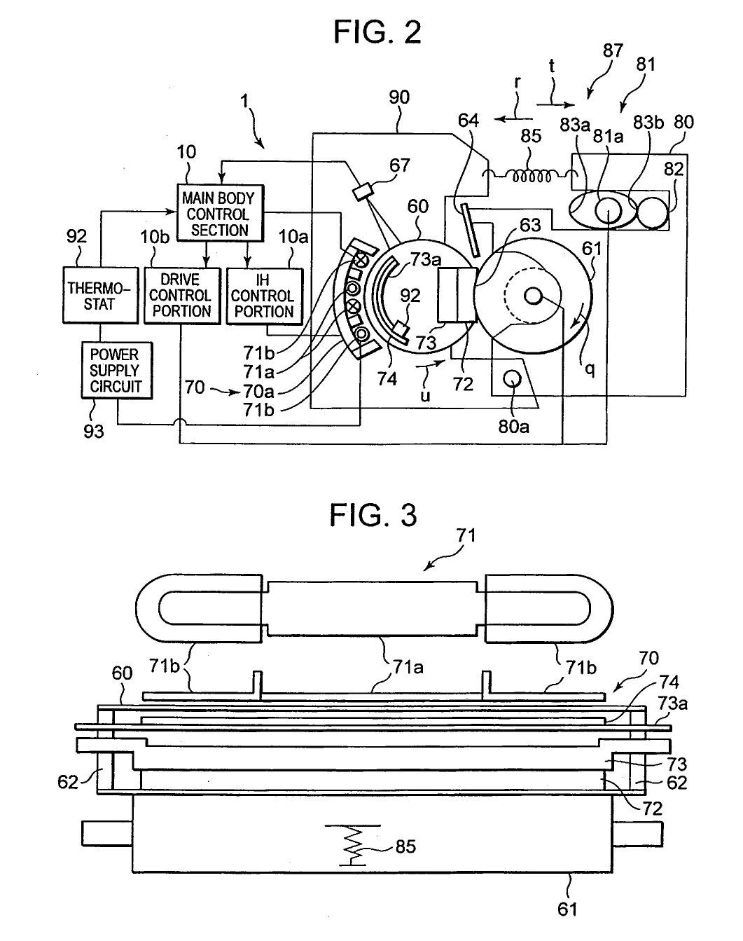

The fixing unit 45 is explained in detail. As shown in FIGS. 2 and 3, the fixing unit 45 includes a fixing belt 60, a press roller 61, an induction-current generating coil (hereinafter abbreviated as IH coil) 70, a pressing pad 72 as a nip forming member, an auxiliary heat generating member 74, and an infrared temperature sensor 67 of a non-contact thermopile type.

The fixing unit 45 includes a peeling blade 64 as a peeling member further on a discharge side of the sheet P than a nip 63 on the circumference of the fixing belt 60.

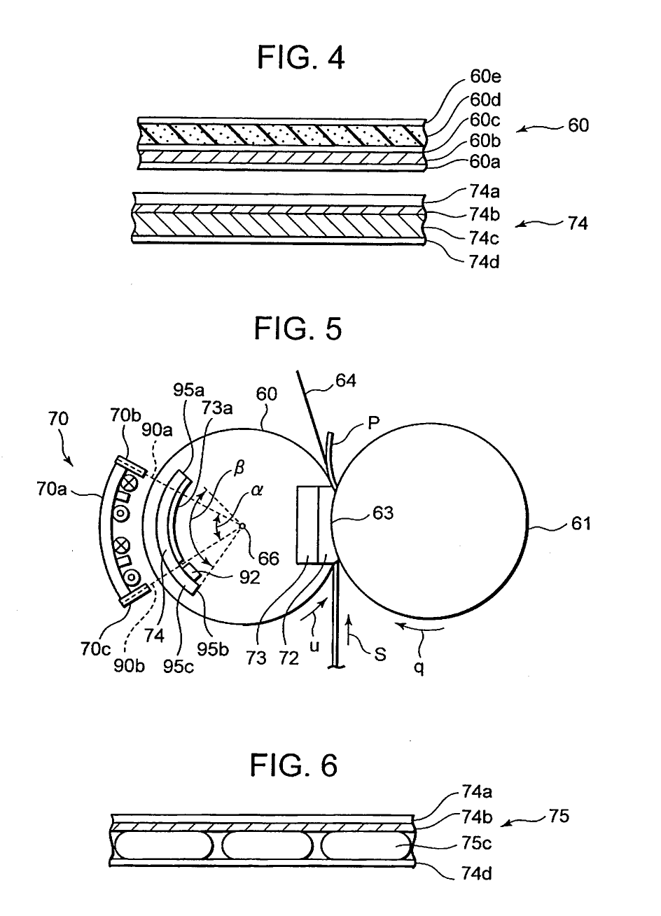

The fixing belt 60 has a multilayer structure. For example, as shown in FIG. 4, the fixing belt 60 includes, a heat generating layer 60b of nickel (Ni) as a metal heat generating layer having thickness of 40 μm, a bonding layer 60c having thickness of 20 μm, a silicon rubber layer 60d having thickness of 200 μm, and a release layer 60e of fluorine resin having thickness of 30 μm around a supporting layer 60a. A material of the heat generating layer 60b may be stainless steel, aluminum (Al), copper (Cu), silver (Ag), a composite material of stainless steel and aluminum, or the like. Flanges 62 support both sides of the fixing belt 60. The fixing belt 60 rotates integrally with the flanges 62 and following or independently from the press roller 61.

The pressing pad 72 is formed of heat-resistant silicon sponge or silicon rubber for example, and has a release layer of fluorine resin on the surface thereof for example. A stay 73 supports the pressing pad 72 and fixes the pressing pad 72 on the inner side of the fixing belt 60.

The press roller 61 includes a heat-resistant silicon sponge or silicon rubber layer around a cored bar for example, and includes a release layer of PFA on the surface thereof. A press roller frame 80 configured to support the press roller 61 includes a fulcrum 80a. The press roller frame 80 pivots, at the fulcrum 80a, with respect to a fixing belt frame 90 configured to support the fixing belt 60. The press roller 61 includes a pressing changing mechanism 87 configured to adjust pressing force of the press roller 61 against the pressing pad 72. The pressing changing mechanism 87 includes a cam 81, a bearing 82, and a pressing spring 85. The pressing spring 85 presses the press roller 61 in an arrow r direction.

The cam 81 has an elliptical shape and includes a cam surface 83a distant from a rotation center 81a and a cam surface 83b close from the rotation center 81a. If the cam surface 83b close from the rotation center 81a of the cam 81 comes into contact with the bearing 82, the pressure of the nip 63 is high. If the cam surface 83a distant from the rotation center 81a of the cam 81 comes into contact with the bearing 82, the press roller frame 80 rotates in an arrow t direction resisting the force in the arrow r direction of the pressing spring 85.

When the fixing unit 45 is used, the cam surface 83b close from the rotation center 81a comes into contact with the bearing 82 and the cam 81 presses the press roller 61 against the pressing pad 72 at high pressure, with the pressing spring 85. When the fixing unit 45 is not used, the cam surface 83a distant from the rotation center 81a comes into contact with the bearing 82. The press roller frame 80 rotates in the arrow t direction, the pressure of the press roller 61 against the pressing pad 72 is reduced, and permanent distortion of the press roller 61 is prevented.

The press roller frame 80 fixes and supports the peeling blade 64. When the fixing unit 45 is used, the peeling blade 64 is opposed to the fixing belt 60 provided along the pressing pad 72 deformed by the high pressure of the press roller 61. When the fixing unit 45 is not used, if the pressure of the press roller 61 against the pressing pad 72 is reduced, the deformed pressing pad 72 is restored. When the pressing pad 72 is restored, the peeling blade 64 is rotated in the arrow t direction by the press roller frame 80 and separates from the pressing pad 72. When the pressing pad 72 is restored, the distal end of the peeling blade 64 does not come into contact with the fixing belt 60. During the peeling, the peeling blade 64 can bring the distal end thereof close to the fixing belt 60 in order to surely peel off the sheet P. During the peeling, a gap between the distal end of the peeling blade 64 and the fixing belt 60 is held at 0.1 to 0.4 mm for example.

The IH coil 70 includes a magnetic core 70a and a coil 71. The magnetic core 70a includes an upstream core 70b at an end on an upstream side and a downstream core 70c at an end on a downstream side, along a rotating direction in an arrow u direction of the fixing belt 60. The magnetic core 70a intensifies a magnetic field formed by the coil 71. A magnetic flux generation region (a heating region) by excitation in the rotating direction of the fixing belt 60 of the IH coil 70 is determined by the upstream core 70b and the downstream core 70c. In the magnetic flux generation region of the IH coil 70, a magnetic flux generation upstream end 90a is determined by the upstream core 70b and a magnetic flux generation downstream end 90b is determined by the downstream core 70c.

The coil 71 includes a first coil 71a configured to generate a magnetic flux over the entire length in a longitudinal direction of the fixing belt 60. The coil 71 includes, on both sides in the longitudinal direction of the fixing belt 60, second coils 71b having a current direction opposite to that of the first coil 71a and configured to cancel the magnetic flux of the first coil 71a.

As the coil 71, for example, a Liz wire obtained by binding one hundred copper wire rods having a wire diameter of 0.2 mm covered by heat-resistant polyamideimide as an insulating material is used. By adopting the Litz wire, it is possible to set a wire diameter smaller than penetration depth and effectively feed an AC current.

A high-frequency current is applied to the first coil 71a to generate a magnetic flux, whereby an eddy-current is generated in the heat generating layer 60b of the fixing belt 60. Joule heat is generated by the eddy-current and the resistance of the heat generating layer 60b to heat the surface over the entire length in the longitudinal direction of the fixing belt 60. The first coil 71a is excited to fix a toner image on the sheet P having width of JIS standard “A4” portrait size (297 mm), for example.

When the first coil 71a and the second coil 71b are excited, the second coil 71b cancels the excitation of the first coil 71a. The first coil 71a and the second coil 71b are excited to fix a toner image on the sheet P having width of JIS standard “A4” landscape size (210 mm), for example.

The heat generating layer 60b of the fixing belt 60 is reduced in heat capacity and thickness in order to enable quick startup. The thickness of the heat generating layer 60b of the fixing belt 60 is smaller than skin depth at a frequency applied to the IH coil 70. The magnetic flux of the IH coil 70 is not effectively utilized in the heat generating layer 60b. A part of the magnetic flux is passed through the heat generating layer 60b.

The auxiliary heat generating member 74 generates heat with the magnetic flux passed through the heat generating layer 60b of the fixing belt 60 and realizes effective utilization of energy. For example, as shown in FIG. 4, the auxiliary heat generating member 74 includes, from the inner circumferential surface side of the fixing belt 60, a release layer 74a of fluorine resin having thickness of 15 μm, a heat generating layer 74b having thickness of 0.2 mm as a second metal heat generating layer, a heat equalizing layer 74c of aluminum having thickness of 0.5 mm, and a protective layer 74d of white PFA resin having thickness of 10 μm. The auxiliary heat generating member 74 keeps the fixing belt 60 warm from the inner circumferential side and prevents the temperature of the fixing belt 60 from dropping.

The second heat generating layer 74b includes a metal layer made of metal such as nickel, stainless steel, or aluminum or a Ni—Fe alloy that is inductively heated, for example. Alternatively magnetic shunt metal having a Curie point of 230° C. may be used for the second heat generating layer 74b, for example, in order to prevent abnormal heat generation. An eddy-current is generated in the second heat generating layer 74b by the magnetic flux of the coil 71 passed through the heat generating layer 60b of the fixing belt 60. The auxiliary heat generating member 74 generates heat with Joule heat by the eddy-current and the resistance of the second heat generating layer 74b.

The heat equalizing layer 74c equalizes the temperature of the auxiliary heat generating member 74 in a direction perpendicular to the traveling direction of the fixing belt 60. For example, a material having high thermal conductivity such as copper or aluminum is used for the heat equalizing layer 74c. Alternatively, as shown in FIG. 6, an auxiliary heat generating member 75 may be formed by using a functional material such as a heat pipe 75c as the heat equalizing layer.

The protective layer 74d protects the heat equalizing layer 74c. The protective layer 74d has a heat reflection preventing function and protects the members arranged on the inner side of the fixing belt 60. The protective layer 74d prevents heat transfer to the members on the inner side of the fixing belt 60.

The auxiliary heat generating member 74 is present on the inner side of the fixing belt 60 and opposed to the magnetic flux generation region of the IH coil 70. A second stay 73a supports the auxiliary heat generating member 74 and fixes the auxiliary heat generating member 74 on the inner side of the fixing belt 60.

The auxiliary heat generating member 74 is spaced apart about 1 mm from the inner circumference of the fixing belt 60, for example. Since the auxiliary heat generating member 74 is spaced apart from the fixing belt 60, the auxiliary heat generating member 74 does not apply a driving load to the fixing belt 60.

A sectional shape of the auxiliary heat generating member 74 is a circular arc which center is a rotation center 66 of the fixing belt 60, for example. For example, a first angle formed by connecting the rotation center 66 of the fixing belt 60 and the magnetic flux generation upstream end 90a and the magnetic flux generation downstream end 90b of the IH coil 70 is represented as an angle α (a magnetic flux generation angle of the IH coil 70 in the rotation center 66). A second angle formed by connecting the rotation center 66 of the fixing belt 60 and an end 95a on the upstream side and an end 95b on the downstream side in the rotating direction of the fixing belt 60 of the auxiliary heat generating member 74 is represented as an angle β (a center angle of the circular arc of the auxiliary heat generating member 74). In the auxiliary heat generating member 74, the center angle β of the circular arc is set larger than the angle α as the magnetic flux generation angle of the IH coil 70, to prevent the magnetic flux of the IH coil 70 passed through the fixing belt 60 from leaking to the periphery of the auxiliary heat generating member 74.

The angle β as the center angle of the auxiliary heat generating member 74 is larger than the angle α as the magnetic flux generation angle of the IH coil 70. The auxiliary heat generating member 74 includes a leak prevention region 95c extending further to the outer side than the angle α with respect to the rotating direction of the fixing belt 60. The leak prevention region 95c includes a thermostat 92 which is contact type on the opposite side of a side opposed to the fixing belt 60. The leak prevention region 95c prevents a leak magnetic flux from the IH coil 70 from affecting the thermostat 92.

The thermostat 92 interrupts power supply to the IH coil 70 by a power supply circuit 93 and prevents abnormal heat generation of the fixing unit 45. Since the thermostat 92 is set in contact with the leak prevention region 95c of the auxiliary heat generating member 74, the thermostat 92 is quick in response according to detection of abnormal heat generation.

In some case, a non-contact thermostat is used in order to prevent the fixing belt from being scratched by contact. In the non-contact thermostat requiring time for response, in some case, temperature for detecting abnormality is set lower to give priority to safety. The temperature is set lower to respond to detection of abnormality in a sudden temperature rise. If priority is given to safety in the non-contact thermostat, it is a risk that inconvenience of disconnection of the thermostat occurs even during normal continuous printing. The thermostat 92 of the contact type is quick in response. The thermostat 92 can be set temperature close to actual abnormal temperature. The thermostat 92 can eliminate the inconvenience of the thermostat slow in response.

The infrared temperature sensor 67 of the non-contact thermopile type detects the temperature of the fixing belt 60 and inputs a detection result to a main body control unit 10 configured to control the MFP 1. The main body control unit 10 controls an IH control unit 10a configured to control application of a high-frequency current to the IH coil 70 and a driving control unit 10b configured to control pressure adjustment or rotation driving for the press roller 61.

When printing is started, the driving control unit 10b controls to rotate the cam 81 of the fixing unit 45 and brings the cam surface 83b close from the rotation center 81a of the cam 81 into contact with the bearing 82. The press roller frame 80 is rotated in the arrow r direction by the spring force of the pressing spring 85. The press roller 61 presses the pressing pad 72 with high pressure. The peeling blade 64 supported by the press roller frame 80 rotates in the arrow r direction. The distal end of the peeling blade 64 is arranged in a peeling position spaced apart 0.1 to 0.4 mm from the fixing belt 60. The driving control unit 10b rotates the press roller 61 in an arrow q direction and rotates the fixing belt 60 in an arrow u direction following or independently from the press roller 61.

The fixing belt 60 rotates while being spaced apart from the auxiliary heat generating member 74. In the fixing belt 60, a driving load due to contact with the auxiliary heat generating member 74 is not generated. The fixing belt 60 is stably driven to rotate.

The IH control unit 10a excites the coil 71 according to a size of the sheet P. The IH control unit 10a feedback-controls the IH coil 70 according to a detection result of the infrared temperature sensor 67 and maintains the fixing belt 60 at fixing temperature. The magnetic flux of the coil 71 generates an eddy-current in the heat generating layer 60b of the fixing belt 60 and heats the fixing belt 60. Further, the magnetic flux of the coil 71 passed through the heat generating layer 60b generates an eddy-current in the heat generating layer 74b of the auxiliary heat generating member 74 and heats the auxiliary heat generating member 74.

The heat of the auxiliary heat generating member 74 conducts to the fixing belt 60 via the space and prevents a temperature drop of the fixing belt 60. The heat of the auxiliary heat generating member 74 conducts to the pressing pad 72 via an adhesive and heats the pressing pad 72. The pressing pad 72 heats the fixing belt 60 from the inner circumference in the position of the nip 63 and keeps the fixing belt 60 warm.

The sheet P having the toner image formed thereon by the transfer unit 44 passes through the nip 63 in an arrow s direction. The sheet P adheres to the fixing belt 60 while the sheet P passes through the nip 63 and the toner image is sufficiently heated. The distal end of the peeling blade 64 peels off the leading end of the sheet P exited the nip 63 from the fixing belt 60. The fixing belt 60 is kept warm by the auxiliary heat generating member 74.

When the printing ends, the driving control unit 10b controls to rotate the cam 81 of the fixing unit 45 and brings the cam surface 83a distant from the rotation center 81a of the cam 81 into contact with the bearing 82. The press roller frame 80 rotates in an arrow t direction resisting the spring force of the pressing spring 85. The press roller 61 reduces the pressure applied to the pressing pad 72. The deformed pressing pad 72 is restored and the surface position of the fixing belt 60 approaches the direction of the peeling blade 64. The peeling blade 64 moves in the arrow t direction according to the rotational movement of the press roller frame 80 and separates from the fixing belt 60.

During the printing, the distal end of the peeling blade 64 maintains the gap of 0.1 to 0.4 mm between the distal end and the fixing belt 60 extending along the pressing pad 72 that is deformed by the pressing force of the press roller 61. The peeling blade 64 surely peels off the sheet P. After the printing finishes, the distal end of the peeling blade 64 surely separates from the fixing belt 60. The distal end of the peeling blade 64 is prevented from coming into contact with the fixing belt 60.

During the printing, in some case, for example, the fixing belt 60 or the auxiliary heat generating member 74 is heated and the fixing unit 45 abnormally generates heat. When the fixing unit 45 abnormally generates heat, the contact thermostat 92 is disconnected. The contact thermostat 92 is disconnected to interrupt the power supply from the power supply circuit 93 to the IH coil 70 by a power supply 94 and stop the abnormal heat generation of the fixing unit 45.

According to the embodiment, the fixing belt 60 is kept warm by the auxiliary heat generating member 74 configured to generate heat using the magnetic flux passed through the fixing belt 60. The auxiliary heat generating member 74 is formed in the arcuate shape having the angle β as the center angle. The angle β is larger than the angle α which is the magnetic flux generation angle of the IH coil 70. Therefore, the auxiliary heat generating member 74 prevents the magnetic flux of the IH coil 70 from leaking to the periphery of the auxiliary heat generating member 74. The influence of the leak magnetic flux from the IH coil 70 does not affect the thermostat 92 of the contact type. Abnormal heat generation of the fixing unit 45 is more accurately detected by using the thermostat 92 of the contact type. The thermostat 92 is not affected by the influence of the leak magnetic flux of the IH coil 70 and is quick in response. Safety of the fixing unit 45 is improved by using the thermostat 92 of the contact type. Since the auxiliary heat generating member 74 is spaced apart from the fixing belt 60, the auxiliary heat generating member 74 does not apply a driving load to the fixing belt 60. The fixing belt 60 rotates stably.

According to the embodiment, the press roller frame 80 fixes and supports the peeling blade 64. During the printing, the distal end of the peeling blade 64 close to the fixing belt 60 to surely peel off the sheet P. After the printing finishes, the distal end of the peeling blade 64 is separated from the fixing belt 60 according to the rotation of the press roller frame 80. The distal end of the peeling blade 64 is surely prevented from coming into contact with the fixing belt 60 irrespective of the restoration of the pressing pad 72.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. A fixing device comprising:
a fixing belt comprising a first metal heat generating layer;
a pressing unit opposing to an outer circumference of the fixing belt;
an induction-current generating coil presented near a circumferential surface of the fixing belt;
a nip forming member present on an inner side of the fixing belt and configured to press the fixing belt against the pressing unit; and
an auxiliary heat generating member present in a heating region by the induction-current generating coil on the inner side of the fixing belt, having a second metal heat generating layer, and extending to an outer side of the heating region by the induction-current generating coil.

2. The device according to claim 1, wherein a sectional shape of the auxiliary heat generating member is an arcuate shape comprising, as a center angle, a second angle larger than a first angle formed by connecting a rotation center of the fixing belt and a magnetic flux generation end on an upstream side and a magnetic flux generation end on a downstream side of the induction-current generating coil in a traveling direction of the fixing belt.

3. The device according to claim 1, further comprising a thermostat set in contact with the auxiliary heat generating member on the outer side of the heating region by the induction-current generating coil.

4. The device according to claim 1, wherein the second metal heat generating layer comprises a magnetic material layer.

5. The device according to claim 1, wherein the auxiliary heat generating member has a heat equalizing layer laminated on the second metal heat generating layer.

6. The device according to claim 1, wherein the auxiliary heat generating member is spaced apart from the fixing belt.

7. The device according to claim 1, wherein the auxiliary heat generating member comprises a heat reflection preventing layer on a surface opposite to a surface opposed to the induction-current generating coil.

8. The device according to claim 1, further comprising, downstream of the nip forming member in a traveling direction of the fixing belt, a peeling member arranged to be opposed to the fixing belt while having a gap between the peeling member and the fixing belt, wherein
the pressing unit moves in a position opposed to the fixing belt to change pressing force on the fixing belt, and
the peeling member moves integrally with the pressing unit.

9. An image forming apparatus comprising:
an image forming unit configured to form an image on a recording medium;
a fixing belt comprising a first metal heat generating layer;
a pressing unit opposed to an outer circumference of the fixing belt;
an induction-current generating coil presented near a circumferential surface of the fixing belt;
a nip forming member present on an inner side of the fixing belt and configured to press the fixing belt against the pressing unit; and
an auxiliary heat generating member present in a heating region by the induction-current generating coil on the inner side of the fixing belt, having a second metal heat generating layer, and extending to an outer side of the heating region by the induction-current generating coil.

10. The apparatus according to claim 9, wherein a sectional shape of the auxiliary heat generating member is an arcuate shape comprising, as a center angle, a second angle larger than a first angle formed by connecting a rotation center of the fixing belt and a magnetic flux generation end on an upstream side and a magnetic flux generation end on a downstream side of the induction-current generating coil in a traveling direction of the fixing belt.

11. The apparatus according to claim 9, further comprising a thermostat set in contact with the auxiliary heat generating member on the outer side of the heating region by the induction-current generating coil.

12. The apparatus according to claim 9, wherein the second metal heat generating layer comprises a magnetic material layer.

13. The apparatus according to claim 9, wherein the auxiliary heat generating member has a heat equalizing layer laminated on the second metal heat generating layer.

14. The apparatus according to claim 9, wherein the auxiliary heat generating member is spaced apart from the fixing belt.

15. The apparatus according to claim 9, wherein the auxiliary heat generating member comprises a heat reflection preventing layer on a surface opposite to a surface opposed to the induction-current generating coil.

16. The apparatus according to claim 9, further comprising, downstream of the nip forming member in a traveling direction of the fixing belt, a peeling member arranged to be opposed to the fixing belt while having a gap between the peeling member and the fixing belt, wherein
the pressing unit moves in a position opposed to the fixing belt to change pressing force on the fixing belt, and
the peeling member moves integrally with the pressing unit.

17. A fixing method comprising:
heating a fixing belt by generate induced current; and
generating heat an auxiliary heat generating member with the induced current passed through the fixing belt, the auxiliary heat generating member extending to an outer side of a generation region of the induction current on an inner side of the fixing belt.

18. The method according to claim 17, further comprising setting a thermostat in contact with the auxiliary heat generating member further on the outer side than the generation region of the induction current with respect to a traveling direction of the fixing belt.

19. The method according to claim 17, wherein the auxiliary heat generating member spaces apart from the fixing belt.

20. The method according to claim 17, further comprising adjusting pressure applied to a nip and moving a peeling member opposed to the fixing belt downstream of the nip in a traveling direction of the fixing belt, according to the adjustment of the pressure.
